(19) United States
(12) Patent Application Publication
(10) Pub. No.: US 2025/0225548 A1
(43) Pub. Date: Jul. 10, 2025

(54) SYSTEM AND METHOD FOR PROVIDING INFORMATION

(71) Applicants: Hyundai Motor Company, Seoul (KR); Kia Corporation, Seoul (KR)

(72) Inventor: Jong Jin LEE, Jongno-gu (KR)

(21) Appl. No.: 18/804,687

(22) Filed: Aug. 14, 2024

(30) Foreign Application Priority Data
Jan. 10, 2024 (KR) 10-2024-0004208

(51) Int. Cl. G06Q 30/0251

(52) U.S. Cl. CPC G06Q 30/0261; G06Q 30/0266

(57) ABSTRACT

A system and method for providing information includes a controller configured to control at least one place-related advertising information when to be output and, first advertisement information of the at least one place-related advertisement information output by an occupant riding in a vehicle is selected, configured to control second advertisement information on a recommended place, which is determined in consideration of a condition corresponding to the number of occupants and a category of a place corresponding to the selected first advertisement information, to be output; and an output device configured to output the at least one place-related advertisement information and the second advertisement information.

### CROSS REFERENCE TO RELATED APPLICATION

The present application claims priority of Korean Patent Application No. 10-2024-0004208 filed on Jan. 10, 2024, the entire contents of which is incorporated herein for all purposes by this reference.

### TECHNICAL FIELD

The present disclosure relates to a system and method for providing specific information to a vehicle user.

### BACKGROUND

Navigation installed in the existing vehicles uses data received from global positioning system (GPS) satellites to show a current location and a traveling direction of a vehicle through a display. When a starting point and a destination are entered, the navigation displays a road, a distance, and an estimated time that the vehicle should travel on a screen.

In addition, the navigation receives real-time traffic information and pre-sets an optimal distance or a road priority using the received traffic information, a current location of the vehicle, and internally stored map information. When a user searches a route, the navigation provides a service for providing information on the searched route based on preset settings. However, the navigation can provide a user with a variety of functions, such as a radio function, a media function, and a location sharing function, as well as a route guidance.

Recently, as the time the user spends in a vehicle increases, it may be necessary to provide functions or services that can increase user convenience using navigation. In particular, it may be necessary to provide advertisement information relevant to the user using the navigation.

### SUMMARY

The present disclosure is directed to a system and method for providing advertisement information in consideration of the number of occupants in a vehicle.

According to one aspect of the present disclosure, a system for providing information includes a controller configured to control at least one place-related advertising information to be output and, when first advertisement information of the at least one place-related advertisement information output by an occupant riding in a vehicle is selected, configured to control second advertisement information on a recommended place, which is determined in consideration of a condition corresponding to the number of occupants and a category of a place corresponding to the selected first advertisement information, to be output; and an output device configured to output the at least one place-related advertisement information and the second advertisement information.

For example, the controller may control at least one place-related advertisement information relating to the occupant to be output on the basis of information on the occupant previously stored in the vehicle.

For example, the controller may provide the information on the occupants to a server equipped to enable mutual communication and control the server to output at least one place-related advertisement information determined on the basis of the information on the occupant.

For example, the advertisement information may include at least one of brand information, menu information, and discount information for at least one place.

For example, when the first advertisement information is selected, the controller may determine the number of occupants based on at least one of a recognition device and a wireless communication device, which are provided in the vehicle.

For example, when the first advertisement information is selected, the controller may provide the selected first advertisement information and the information on the determined number of occupants to a server equipped to enable mutual communication, and the controller may receive the second advertisement information, which is determined on the basis of the information provided by the server, and control second advertisement information to be output through the output device.

For example, when a recommended place located within a certain radius is determined based on the place corresponding to the selected first advertisement information in consideration of the condition corresponding to the number of occupants and the category of the place corresponding to the selected first advertisement information on the basis of the information provided by the server, the controller may receive second advertisement information corresponding to the determined recommended place.

For example, when the place corresponding to the selected first advertisement information coincides with the determined recommended place, the controller may control second advertisement information containing the same information as the first advertisement information to be output.

According to another aspect of the present disclosure, a method of providing information includes outputting at least one place-related advertisement information; when first advertisement information of the at least one place-related advertisement information output by an occupant riding in a vehicle is selected, determining a recommended place in consideration of a condition corresponding to the number of occupants and a category of a place corresponding to the selected first advertisement information; and outputting second advertisement information on the determined recommended place.

For example, the outputting of the place-related advertisement information may include outputting at least one place-related advertisement information relating to the occupant on the basis of information on the occupant previously stored in a vehicle.

For example, the outputting of the place-related advertisement information may include providing the information on the occupants to a server equipped to enable mutual communication and outputting at least one place-related advertisement information determined by the server on the basis of the information on the occupant.

For example, the determining of the recommended place may include, when the first advertisement information is selected, determining the number of occupants based on at least one of a recognition device and a wireless communication device, which are provided in the vehicle.

For example, the determining of the recommended place may include, when the first advertisement information is selected, providing the selected first advertisement information and the information on the determined number of occupants to a server equipped to enable mutual communication, and determining the recommended place on the basis of the information provided by the server.

For example, the determining of the recommended place may include, determining a recommended place located within a certain radius based on the place corresponding to the selected first advertisement information in consideration of a condition corresponding to the number of occupants and a category of the place corresponding to the selected first advertisement information on the basis of the information provided by the server.

For example, the outputting of the second advertisement information may include, when the place corresponding to the selected first advertisement information coincides with the determined recommended place, outputting second advertisement information containing the same information as the first advertisement information.

### BRIEF DESCRIPTION OF THE DRAWINGS

FIG. 1 is a block diagram illustrating an example of a system for providing information.

FIG. 2 is a block diagram for describing an example of an operation of a controller.

FIG. 3 is a flowchart for describing an example of a method of providing information.

### DETAILED DESCRIPTION

In describing embodiments disclosed in the present specification, when a detailed description of a known related art is determined to obscure the gist of the present specification, the detailed description thereof will be omitted herein. In addition, the accompanying drawings are merely for easy understanding of the embodiments disclosed in the present specification, the technical spirit disclosed in the present specification is not limited by the accompanying drawings, and it should be understood to include all modifications, equivalents, and substitutes included in the spirit and scope of the present disclosure.

Terms including ordinal numbers such as first, second, and the like used herein may be used to describe various components, but the various components are not limited by these terms. The terms are used only for the purpose of distinguishing one component from another component.

When a component is referred to as being “connected” or “coupled” to another component, the component may be directly connected or coupled to another component, but it should be understood that sill another component may be present between the component and another component. Conversely, when a component is referred to as being “directly connected” or “directly coupled” to another, it should be understood that still another component may not be present between the component and another component.

Unless the context clearly dictates otherwise, the singular form includes the plural form.

In the present specification, the terms “comprising,” “having,” or the like are used to specify that a feature, a number, a step, an operation, a component, an element, or a combination thereof described herein exists, and they do not preclude the presence or addition of one or more other features, numbers, steps, operations, components, elements, or combinations thereof.

Hereinafter, embodiments disclosed in the present specification will be described in detail with reference to the drawings. The same reference numerals are given to the same or similar components regardless of reference numerals, and a repetitive description thereof will be omitted.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

First, the objective of the present disclosure is to provide vehicle occupants with at least one place-related advertisement information relating to the vehicle occupants. In particular, when first advertisement information is selected by a vehicle occupant among pieces of provided advertisement information, the objective of the present disclosure is to provide additional second advertisement information in consideration of the selected first advertisement information and the number of vehicle occupants.

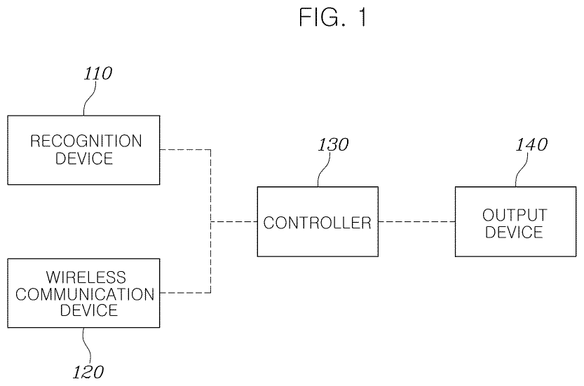

A system for providing information will be described with reference to FIG. 1.

FIG. 1 is a block diagram illustrating the system for providing information.

Referring to FIG. 1, the system for providing information may include a recognition device 110, a wireless communication device 120, a controller 130, and an output device 140. FIG. 1 mainly shows components related to the implementation of the present disclosure, and it is a matter of course that fewer or more components may be included in implementation of an actual system for providing information.

Hereinafter, each component will be described.

The recognition device 110 is provided in s vehicle, and in particular, may be provided in an interior space of the vehicle. For example, the recognition device 110 may include sensors such as a camera, radio detecting and ranging (RADAR), and a seat sensor which are provided in the interior space of the vehicle. However, this is an example and the present disclosure is not necessarily limited thereto.

The wireless communication device 120 may include a communication device equipped with a Bluetooth or Wi-Fi function that is installed in the vehicle and communicates with a portable terminal of a vehicle occupant or may include a communication device that recognizes a smart key of an occupant. However, this is an example and the present disclosure is not necessarily limited thereto.

The recognition device 110 and the wireless communication device 120 may each transmit sensed or recognized information to the controller 130.

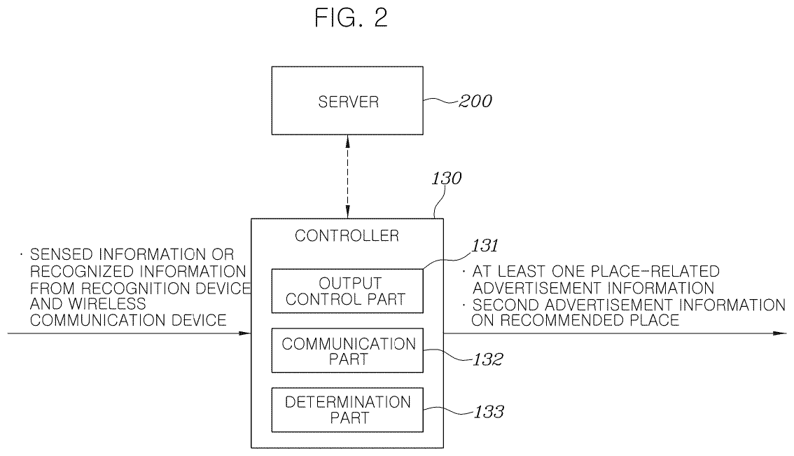

The controller 130 controls at least one place-related advertisement information to be output, and when first advertisement information is selected among output pieces of advertisement information by an occupant in the vehicle, the controller 130 may control an output of second advertisement information determined in consideration of the selected advertisement information and the number of occupants. This will be described in detail with reference to FIG. 2.

In some implementations, in the implementation of the controller 130, the controller 130 may be implemented as a function of an Audio/Video/Navigation (AVN) controller for controlling an AVN system installed in the vehicle. However, this is an example and the present disclosure is not necessarily limited thereto. For example, the controller 130 may be implemented as a separate controller from the AVN controller, or functions of the controller 130 may be implemented in a distributed form in two or more different controllers.

FIG. 2 is a block diagram for describing an operation of a controller.

Referring to FIG. 2, the controller 130 can include an output control part 131, a communication part 132, and a determination part 133. This shows components relating to the operation of the controller 130, and of course, when an actual controller 130 is implemented, fewer or more components may be included.

Hereinafter, each component will be described.

In some implementations, a situation is assumed that at least one place-related advertisement information is output to the vehicle.

Thus, the output control part 131 may control an output of at least one place-related advertisement information. Specifically, the output control part 131 may control the output of at least one place-related advertisement information relating to occupants on the basis of information on occupants previously stored in the vehicle. For example, the information on occupants previously stored in the vehicle may include an occupant's gender, an age range, tastes, frequently used places, and frequently used routes, and advertising information may include brand information, menu information, and discount information, which relate to at least one place. However, this is an example and the present disclosure is not necessarily limited thereto.

Meanwhile, the output control part 131 may transmit the information on occupants previously stored in the vehicle to a server 200, which is provided to enable mutual communication outside the system for providing information, and may receive at least one place-related advertisement information determined on the basis of the information on occupants from the server 200.

To this end, the output control part 131 may transmit the information on occupants previously stored in the vehicle to the communication part 132. The communication part 132 may communicate with the server 200 and transmit the information on occupants transmitted from the output control part 131 to the server 200.

In this case, the server 200 may include a communication device for communicating with the controller 130 or the communication part 132 to perform a function in charge, a memory which stores an operating system, a logic command, and input/output information, and one or more processors for performing determination, an arithmetic operation, and judgment which are necessary to control the function in charge. For example, the server 200 may be a vehicle server which provides various pieces of information, functions, and services to the vehicle, but of course, this is an example and the present disclosure is not necessarily limited thereto.

The server 200 may determine at least one place-related advertisement information relating to occupants on the basis of the information on occupants transmitted through the communication part 132. In addition, the server 200 may transmit the determined at least one place-related advertisement information back to the communication part 132, and the communication part 132 may transmit the at least one place-related advertisement information transmitted from the server 200 to the output control part 131.

In other words, the output control part 131 may receive the at least one place-related advertisement information determined by the server 200 through the communication part 132 and may control the provided at least one place-related advertisement information to be output.

Thereafter, when first advertisement information of the output at least one place-related advertisement information is selected by the occupant, the determination part 133 may determine the number of occupants based on at least one of the recognition device 110 and the wireless communication device 120 provided in the vehicle. For example, the determination part 133 may receive information sensed or recognized through at least one of the recognition device 110 and the wireless communication device 120 and may determine the number of occupants on the basis of the provided information.

In addition, the determination part 133 may provide the server 200 with the first advertisement information selected by the occupant and information on the determined number of occupants. In this case, the determination part 133 may provide the first advertisement information and the information on the determined number of occupants to the server 200 through the above-described communication part 132.

The server 200 may determine a condition corresponding to the number of occupants and a category of a place corresponding to the selected first advertisement information on the basis of the provided first advertisement information and the information on the determined number of occupants.

In this case, the category of the place may mean that the place is classified according to the industry or product handled, and the determination of the category of the place corresponding to the first advertisement information may mean determining whether the place corresponding to the selected first advertisement information is a restaurant or a cafe. However, this is an example and the present disclosure is not necessarily limited thereto.

In addition, the server 200 may determine a condition corresponding to the number of occupants and the category of the place corresponding to the selected first advertisement information and determine a recommended place by considering the condition and the category.

For example, the condition corresponding to the number of occupants may mean a discount rate according to the number of occupants already stored in the server 200 and may be stored such that as the number of occupants increases, a corresponding discount rate increases. In addition, the discount rate may be higher than the discount rate included in the first advertisement information previously selected by the occupant. For example, when the discount rate included in the first advertisement information is 10%, the condition corresponding to the number of occupants, which is the discount rate corresponding to three occupants, may be 208, and the condition corresponding to the number of occupants, which is the discount rate corresponding to five occupants, may be 30%. However, this is an example and the present disclosure is not necessarily limited to the above number.

In other words, the server 200 may determine a recommended place that is located within a certain radius around the place corresponding to the previously selected first advertisement information and offers a higher discount rate than the discount rate included in the first advertisement information in consideration of the condition corresponding to the number of occupants and the category of the place corresponding to the selected first advertisement information.

When the recommended place is determined, the server 200 may provide second advertisement information on the recommended place to the communication part 132.

The communication part 132 may transmit the second advertisement information on the recommended place provided from the server 200 to the output control part 131, and the output control part 131 may control the second advertisement information on the recommended place provided by the communication part 132 to be output.

For example, at least one place-related advertisement information may be output to the vehicle through the output control part 131, and the at least one place-related advertisement information output may be advertisement information relating to a cafe. The occupant may select the first advertisement information, which is one for providing a discount rate of 10%, f the output at least one place-related advertisement information. When the first advertisement information is selected, the second advertisement information on the recommended place may be output through the operation of each component of the above-described controller 130. In this case, the output recommended place may be a cafe in the same category as the place corresponding to the previously output advertisement information, and the second advertisement information on the recommended place may be advertisement information that provides a higher discount rate than the discount rate of 10% selected by the previous occupants in consideration of the number of occupants. However, this is an example and the present disclosure is not necessarily limited thereto.

In this way, the occupant may receive the second advertisement information containing higher discount information suitable for the number of occupants than the initially selected first advertisement information, and the server 200 may provide the second advertisement information containing higher discount information suitable for the number of occupants so that the occupants can be encouraged to increase a utilization rate of the recommended place corresponding to the second advertisement information.

However, when the place corresponding to the first advertisement information selected by the occupant coincides with the recommended place determined by the server 200, the second advertisement information on the recommended place provided by the server 200 may include the same information as the first advertisement information selected by the occupant, and thus the second advertisement information may be the same information as the first advertisement information. That is, when the place corresponding to the first advertisement information selected by the occupants coincides with the recommended place determined by the server 200, the output control part 131 may control the second advertisement information on the recommended place containing the same information as the selected first advertisement information to be output.

Referring back to FIG. 1, as described above, the controller 130 can control at least one place-related advertisement information to be output, and when the first advertisement information of the at least one place-related advertisement information output by the occupant is selected, the controller 130 may control the second advertisement information on the recommended place determined in consideration of the first advertisement information and the number of occupants to be output.

In other words, the controller 130 may transmit the at least one place-related advertisement information and the second advertisement information on the recommended place to the output device 140 provided in the vehicle, and the output device 140 may output the information received from the controller 130. That is, the output device 140 may output the advertisement information to allow the occupant to check the advertisement information.

For example, the output device 140 may be a display device provided in a vehicle to visually and audibly output advertisement information. The display device may be implemented as a cluster, a head-up display (HUD), or a display of an AVN system. However, this is an example, and of course, in addition to the above-described device, a variety of devices may be applied as the output device 140.

In addition, when the output device 140 is a navigation system installed in a vehicle, the output device 140 may output the at least one place-related advertisement information and the second advertisement information on the recommended place on a map provided in the navigation system. In particular, the output device 140 may output brand pins at locations of places of interest and recommended places, and advertisement information for each place may be linked with location information of each place to be output in the form of a pop-up from a corresponding brand pin. However, this is an example and the present disclosure is not necessarily limited thereto.

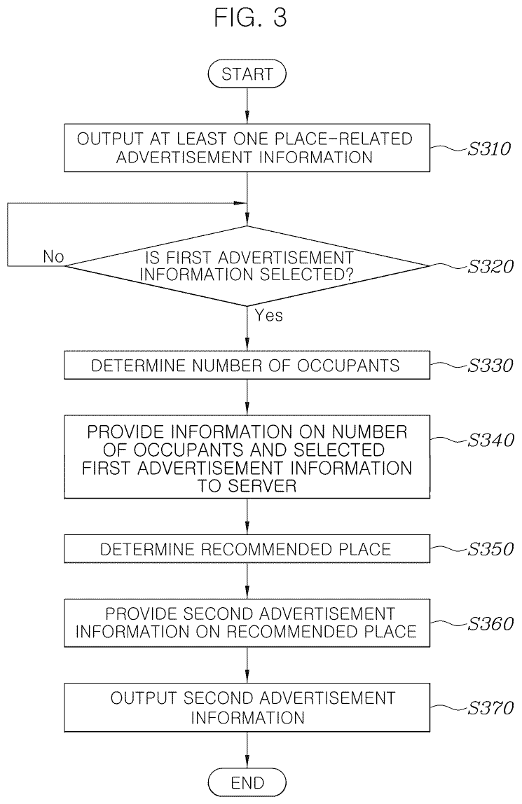

Hereinafter, a method of providing information will be described with reference to FIG. 3 based on the configuration of the system for providing information described above in FIGS. 1 and 2. A detailed description of each operation is described in detail in FIGS. 1 and 2, and thus the detailed description thereof will be omitted.

In addition, hereinafter, for convenience of description, it is assumed that each operation is performed in batches in the controller 130.

FIG. 3 is a flowchart for describing a method of providing information.

Referring to FIG. 3, the controller 130 may control at least one place-related advertisement information relating to occupants on the basis of information on the occupants previously stored in the vehicle to be output through the output device 140 (S310).

When a first advertisement information of the at least one place-related advertisement information output to the output device 140 by the occupants riding in the vehicle is selected (Yes of S320), the controller 130 may determine the number of occupants riding in the vehicle (S330).

In addition, the controller 130 may provide information on the determined number of occupants and the selected first advertisement information to the server 200 (S340), and the server 200 may determine a recommended place on the basis of the first advertisement information and the information on the number of occupants, which are provided by the controller 130 (S350).

When the recommended place is determined, the server 200 may provide the second advertisement information on the determined recommended place to the controller 130 again (S360), and the controller 130 may control the second advertisement information provided by the server 200 to be output through the output device 140 (S370).

As described above, according to the system and method for providing information of the present disclosure, when an occupant in a vehicle selects one advertisement information among pieces of advertisement information displayed on the vehicle, advertisement information is provided in consideration of the number of occupants and the selected advertisement information so that there is an effect of providing advertisement information optimized for the number of occupants in the vehicle and occupants' choices.

In particular, by providing discount information together with advertisement information in consideration of the number of occupants in the vehicle, there is an effect of increasing a utilization rate of a place corresponding to the advertisement information for the occupants in the vehicle and performing advertisement and promotion of the corresponding place.

In accordance with a system and method for providing information of the present disclosure, when an occupant in a vehicle selects one advertisement information among pieces of advertisement information displayed on the vehicle, advertisement information is provided in consideration of the number of occupants and the selected advertisement information so that there is an effect of providing advertisement information optimized for the number of occupants in the vehicle and occupants' choices.

In particular, by providing discount information together with advertisement information in consideration of the number of occupants in the vehicle, there is an effect of increasing a utilization rate of a place corresponding to the advertisement information for the occupants in the vehicle and performing advertisement and promotion of the corresponding place.

The effects obtained by the present disclosure are not limited to the above-mentioned effects and other effects which are not mentioned can be clearly understood by those skilled in the art to which the present disclosure pertains from the description.

Although specific implementations of the present disclosure have been described and illustrated, those skilled in the art will appreciate that various alternations and modifications are possible without departing from the technical spirit of the present disclosure as disclosed in the appended claims.

The above-described present disclosure can be implemented as computer-readable codes in a medium on which a program is recorded. The computer-readable medium includes all types of recording devices in which data readable by a computer system is stored. Examples of the computer-readable medium include hard disk drives (HDDs), solid state disks (SSDs), silicon disk drives (SDDs), read only memories (ROMs), random access memories (RAMs), compact disc ROMs (CD-ROMs), magnetic tapes, floppy disks, and optical data storage devices. Therefore, the above detailed description should not be construed as restrictive in all respects and should be considered as illustrative. The scope of the present disclosure should be determined by a reasonable interpretation of the appended claims, and all modifications within the equivalent scope of the present disclosure are included in the scope of the present disclosure.

What is claimed is:

1. A system for providing information in a vehicle, comprising:
an output device configured to output information;
a memory storing instructions; and
a controller configured to execute the instructions to perform operations comprising:
controlling the output device to output at least one information related to location-based promotional content,
controlling, based on first information of the at least one information being selected by a passenger of the vehicle, the output device to output second information regarding a recommended place that is determined according to a condition corresponding to a number of occupants in the vehicle and a category of a place corresponding to the selected first information,
controlling the output device configured to output the at least information related to location-based promotional content and the second information.

2. The system of claim 1, wherein outputting the at least one information comprises outputting at least one information related to location-based promotional content and related to the passenger based on information regarding the passenger previously stored in the vehicle.

3. The system of claim 2, wherein outputting the information comprises providing, to a server equipped to enable mutual communication, the information regarding the passenger to thereby cause the server to output at least one information related to location-based promotional content that is determined based on the information regarding the passenger.

4. The system of claim 1, wherein the at least one information related to location-based promotional content includes at least one of brand information, menu information, or discount information for at least one location.

5. The system of claim 1, wherein determining the recommended place comprises determining, based on the first information being selected, the number of passengers according to at least one of a recognition device or a wireless communication device, which are provided in the vehicle.

6. The system of claim 1, wherein the operations further comprise:
providing, based on the first information being selected, the selected first information and the information regarding the determined number of passenger to a server equipped to enable mutual communication,
receiving the second information that is determined based on the information provided by the server, and
controlling the output device to output the second information.

7. The system of claim 6, wherein the operations further comprise receiving, when a recommended place located within a certain radius is determined based on the place corresponding to the selected first information in consideration of the condition corresponding to the number of passengers and the category of the place corresponding to the selected first information on the basis of the information provided by the server, the second information corresponding to the determined recommended place.

8. The system of claim 1, wherein the operations further comprise controlling, based on the place corresponding to the selected first information matching the determined recommended place, the output device to output the second information including the same information as the first information.

9. A method of providing information in a vehicle, the method comprising:
outputting at least one information related to location-based promotional content;
determining, based on first information of the at least one information being selected by a passenger of the vehicle, a recommended place according to a condition corresponding to a number of passengers and a category of a place corresponding to the selected first information; and
outputting second information regarding the determined recommended place.

10. The method of claim 9, wherein outputting the information includes outputting at least one information related to location-based promotional content and related to the passenger based on information regarding the passenger previously stored in a vehicle.

11. The method of claim 10, wherein outputting the information includes providing, to a server equipped to enable mutual communication, the information regarding the passenger to thereby cause the server to output at least one information related to location-based promotional content that is determined based on the information regarding the passenger.

12. The method of claim 9, wherein determining the recommended place includes determining, based on the first information being selected, the number of passengers according to at least one of a recognition device or a wireless communication device, which are provided in the vehicle.

13. The method of claim 9, wherein determining the recommended place includes:
providing, based on the first information being selected, the selected first information and the information regarding the determined number of passengers to a server equipped to enable mutual communication, and
determining the recommended place based on the information provided by the server.

14. The method of claim 13, wherein determining the recommended place includes determining a recommended place located within a certain radius based on the place corresponding to the selected first information in consideration of a condition corresponding to the number of passengers and a category of the place corresponding to the selected first information on the basis of the information provided by the server.

15. The method of claim 9, wherein outputting the second information includes outputting, based on the place corresponding to the selected first information matching the determined recommended place, second information including the same information as the first information.
